(19) United States
(12) Patent Application Publication
(10) Pub. No.: US 2005/0281391 A1
(43) Pub. Date: Dec. 22, 2005

(54) Active vibration control in computed tomography systems

(75) Inventors: Huageng Luo, Clifton Park, NY (US); Darren Lee Hallman, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/872,863

(22) Filed: Jun. 21, 2004

(51) Int. Cl. H01J 35/04; H05G 1/00

(52) U.S. Cl. 378/204

(57) ABSTRACT

An apparatus for active vibration is provided for control of resonance vibrations in a computed tomography (CT) system. The apparatus comprises a sensor coupled to a support frame of the CT system for detecting resonance vibrations and and convert the vibration signal to a corresponding electrical signal. The apparatus further comprises a control device coupled to the sensor for implementing a control algorithm to process the electrical signal to generate a corresponding control signal, which is used for counteracting the resonance vibrations in the support frame.

### BACKGROUND OF THE INVENTION

The invention generally relates to computed tomography (CT) systems, and more specifically to vibration control in CT systems.

Generally, conventional CT systems comprise a rotating gantry, and functioning components such as an X-ray source and a detector are typically mounted on the rotating gantry. The patient to be imaged is placed at the geometric center of the gantry. During CT operations, the patient is stationary, while the X-ray source and/or the detector are rotated around the patient, in some cases at different speeds, to capture an image. For high quality and high-resolution images, relative motion between the rotating gantry's geometric center and the patient being imaged need to be minimal.

However, there exist multiple sources causing a relative motion between the patient and the gantry geometric center, which include i) irregularity of the bearing and rotating gantry geometry, ii) static and dynamic unbalances of rotating parts mounted on the rotating gantry and iii) occurrence of resonance when rotating harmonics of the gantry coincide with the supporting frame natural frequency. The irregularity of the bearing and rotating gantry geometry, and the static and dynamic unbalances of the rotating parts mounted on the rotating gantry, can be addressed through manufacturing quality control. However, mechanical excitations induced by resonance vibrations can distort the image and present a challenge.

More specifically, various functioning components such as the X-ray tube, detector and other control components are fixed on the gantry and may be considered as lumped masses attached to a substantially uniform rotating base. During the operation of the CT system, the gantry rotates at a constant speed for a given imaging condition, which causes an application of the centrifugal forces on the on the lumped masses. These forces may deform the rotating base, and, in general, the deformation in the rotating base is expected to be irregular, such as circular, elliptical, triangular, among others. These may also be referred to as “in plane” deformations. Due to a distance between the plane of bearing of the CT system and the plane of attachment of lumped masses, “out-of-plane” deformations are also expected. Besides causing deformations, the mechanical excitations comprise vibrations corresponding to fundamental frequency of rotation of up to 4 Hz or higher and other harmonics. Further, the gantry is operated at multiple speeds corresponding to multiple imaging conditions, which manifolds the mechanical excitations including the potential excitation frequencies supplied to the CT system in ways discussed above.

Further, multiple gantry rotating speeds required in current and upcoming CT systems, such as those about 5 Hz, and the natural frequencies of the massive CT systems, typically below 10 Hz are highly probable to coincide, causing a resonance. This resonance of the CT frame natural frequency (or one of its harmonics) with the rotating frequency of the gantry leads to undesirable vibrations and distortion in the images obtained. The resonance vibrations may cause a relative motion between the patient and the geometric center of the gantry, of the order of a few millimeters, which substantially distorts a scanned image.

Conventional approaches to reduce such vibrations include damping vibrations by the use of viscoelastic materials or other kinetic energy dissipating materials. However, the damping approach is only suitable for higher order frequencies, such as over 100 Hz, and hence cannot be applied to most CT systems. Another conventional approach, a tuned vibration absorber, transfers a main system's vibration energy to an auxiliary system (tuned to have the natural frequency of the main system), thereby reducing the vibration in the main system. Given the massive nature of the CT systems, an auxiliary system as a tunable vibration absorber will itself need to be massive, and is hence, impractical.

Thus, there exists a need for methods and systems to effectively reduce such vibrations in CT systems, while overcoming the associated disadvantages of the conventional approaches. It will be further desirable to employ a technique that is not limited by a vibration frequency.

### BRIEF DESCRIPTION OF THE INVENTION

Briefly, in accordance with an embodiment of the invention, an apparatus for active vibration control of resonance vibrations in a computed tomography (CT) system is provided. The apparatus comprises a sensor coupled to a support frame of the CT system. The sensor detects resonance vibrations signals in the support frame and converts the vibration signals to a corresponding electrical signal. A control device coupled to the sensor implements a control algorithm to process the electrical signal to generate a corresponding control signal. The control signal is used for counteracting the resonance vibrations in the support frame.

According to another embodiment, a method for controlling resonance vibrations in a CT system comprises sensing a vibration in a support frame of the CT system to generate a vibration signal, implementing a control algorithm on the vibration signal to generate control signals, the control signals configured to suppress the vibration in the support frame.

### BRIEF DESCRIPTION OF THE DRAWINGS

FIG. 1 is a front view schematic of a CT system coupled to an active vibration control apparatus, according to an embodiment.

FIG. 2 is a block diagram illustrating an embodiment of the active vibration control apparatus.

### DETAILED DESCRIPTION OF THE INVENTION

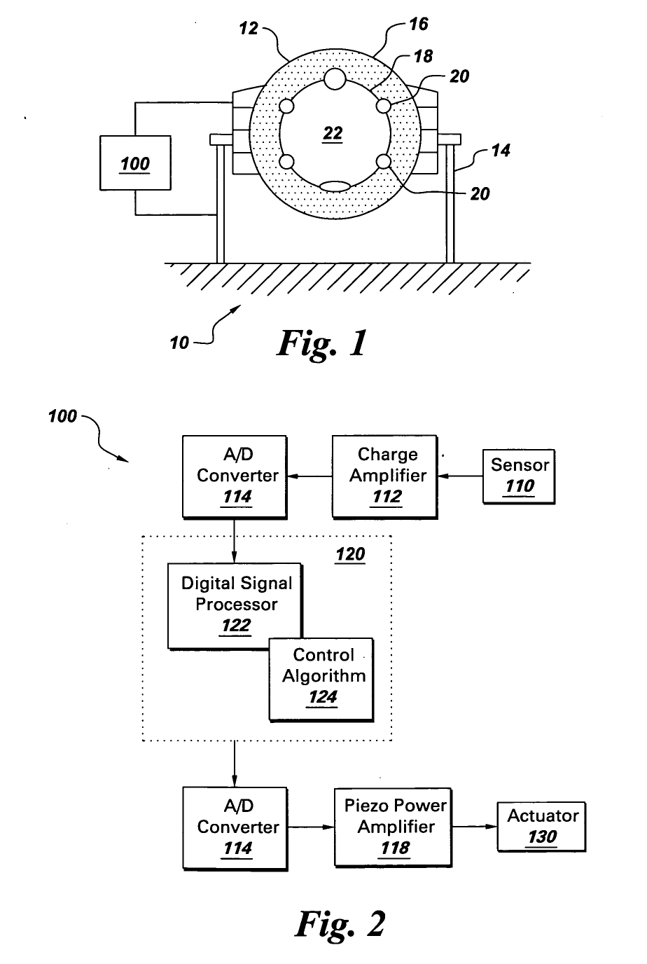

FIG. 1 is illustrates a CT system 10, having a gantry 12 mounted over a support frame 14, which is coupled to an active vibration control apparatus 100. The gantry is functional to expose a volume to radiation for imaging. The gantry typically includes a stationary base 16 mounted on the support frame, and a rotating base 18 is positioned inside the stationary base. Wherever used, the term “rotating gantry” will be understood to refer to the rotating base of the gantry. Further, the “geometric center” of the gantry is understood to refer to the geometric center of the radiation source and detector elements, and in most cases is the geometric center of the rotating base. The rotating base is mounted with various functional components 20 of the CT system, such as an X-ray source(s), detector array(s), computer modules, among others. These components can be viewed as masses lumped to the rotating base. The imaging volume 22 inside the rotating base is suitable for positioning an object of interest, such as a patient (not shown in the figure), for the purpose of imaging.

In operation, the patient is typically positioned at a specific position within the volume 22, such as the gantry geometric center, for the purpose of imaging. Radiation from the X-ray source(s) impinges upon the relevant volume of the patient body, and may be modified (attenuated or deflected) due to the interaction with the patient body. This modified radiation is detected by the detectors, and processed by the computer modules to generate an image of the relevant portion of the patient. Many such equivalent CT systems exist, and in all these systems while under operation, the rotating base rotates at varied speeds, to enable the X-ray source and the detectors scan the patient volume from varied positions. The rotating base and the lumped components are typically heavy masses that rotate along with the rotating base and cause vibrations in the support frame due to resonance with potential excitations from the rotating base, or simply referred to as “resonance vibrations”. The relative motion of the patient with respect to the X-ray source and the detector needs to be minimal for an accurate generation of the image, and the resonance vibrations induced in the support frame may cause a relative motion. To avoid distortion in image due to these vibrations, and according to an embodiment of the invention, the active vibration control apparatus 100 coupled to the CT system is configured to counter the vibrations in the support frame.

As used herein, “mounted”, “coupled”, “adapted to”, “configured” and the like refer to mechanical or structural connections between elements to allow the elements to cooperate to provide a described effect; these terms also refer to operation capabilities of electrical elements such as analog or digital computers or application specific devices (such as an application specific integrated circuit (ASIC)) that are programmed to perform a sequel to provide an output in response to given input signals.

According to an embodiment, the active vibration control apparatus 100 includes a (meaning at least one) sensor 110 coupled to the support frame 14. The sensor is configured to detect resonance vibrations in the support frame. After detecting such vibrations, the sensor converts these mechanical vibration signal(s) to corresponding electrical signal(s). The apparatus 100 also includes a control device 120 that is coupled to the sensor and responsive to the electrical signal. The control device is configured to process the electrical signal obtained from the sensor by implementing a control algorithm, based on which, the control device generates a corresponding control signal. The control signal thus generated is used for counteracting resonance vibrations in the support frame. It is to be appreciated that the control apparatus is closed-loop in that the control signal is generated responsive to the signal from the sensor in order to counteract the resonance vibrations.

As used herein, terms “counteract”, “counteracting”, “counters” and the like will be understood to imply a nullifying or a substantially nullifying action or a suppressing action. Alternate terms such as “suppress” and the like have been interchangeably used in the discussion.

FIG. 2 is an embodiment of the active vibration control apparatus 100 to reduce the resonance vibrations in CT systems. The sensor 110 is coupled to a charge amplifier 112, which in turn is coupled and analog to digital (A/D) converter (ADC) 114, which is coupled to the control device 120. According to an embodiment, the control device comprises a digital signal processor (DSP) 122 that is configured to implement the control algorithm 124 for processing the electrical signal received from the sensor, to generate the corresponding control signal. The control device is coupled to a digital to analog (D/A) converter 116, which is coupled to a piezo power amplifier 118. The piezo power amplifier is further coupled to an actuator 130. A description of each component is discussed in further detail below.

In related embodiments, the sensor 110 mounted on the support frame 12 may be selected from a variety of sensors. In the illustrated embodiments, the sensor is a lead-zirconate-titanate (PZT) wafer stack. Examples of other suitable sensors that may be used include, without limitation, an accelerometer, velocity sensor, displacement sensor, deformation sensor, strain gauge, piezo wafer, and a Polyvinyl Fluoride (PVDF) film sensor. It will be appreciated that a variety of other sensors for detecting vibrations in the support frame may be equivalently used. Further, any one, or a combination of any one of the above sensors, or other sensing means in general capable of detecting vibrations and converting the detected vibrations to corresponding characteristic electric signals, may be used for detecting resonance vibrations. According to a related embodiment, the sensor detects resonance vibration signals and converts the vibration signals to an alternating current (AC) voltage signal.

Charge amplifier 112 is coupled to the sensor 110 and receives the electrical signal generated by the sensor. The charge amplifier amplifies the electrical signal to a desired voltage level, generating an amplified electrical signal.

The Analog to Digital Converter 114, hereinafter referred to as ADC, receives and converts the amplified electrical signal from an analog AC configuration to a digital electrical signal. In the illustrated embodiments, the ADC comprises a commercially available National Instrument NI-6025E, which provides both A/D and D/A converters. Other ADCs can also be used.

The DSP 122 coupled to the ADC 114, receives the digital electrical signal from the ADC. The DSP implements a control algorithm 124 to process the digital electrical signal to generate a corresponding control signal for counteracting the resonance vibrations.

In an alternate embodiment, the control device may comprise a computer unit for the CT system capable of executing programmable instructions to implement the control algorithm, and storing and retrieving data such as programmable instructions. Accordingly, such a control device is capable of performing various functions including charge amplification, A/D conversion, implementation of control algorithms, D/A conversions, among others. According to an embodiment, the computer module functional for image generation may be additionally used as a control device.

Various embodiments may use any one or a combination of various control algorithm techniques, such as, a positive position feedback (PPF) control technique, an acceleration feed back control technique, a velocity feed back control technique, a collocated rate feedback control technique, among others. Due to different ways different sensors function, each sensor may require a corresponding appropriate control algorithm modification, and use of specific control algorithms are not limiting to the disclosed embodiments. For example, if an accelerometer is used as a sensor, the acceleration feedback control should be used, while if a velocity sensor is used, velocity feedback control should be used. In general, control algorithms may be based on developing transfer functions from a number of measurments of vibrations and resonance effects. It will be appreciated that those skilled in the art could equivalently apply other techniques for processing the electrical signals for generating control signals. In the illustrated embodiment the PPF control technique, which is generally known in the art, has been used and is described in the following.

The single degree of freedom (DOF) equation for the PPF control of a structure consists of the structure modal equation with feedback and the compensator modal equation with sensing. The structure modal equation is given below:

$$\{ \begin{matrix}\ddot{ξ} + {β}_{s} \dot{ξ} + {ω}_{s}^{2} ( ξ - γη ) = f ( t ) \\ \ddot{η} + {β}_{c} \dot{η} + {ω}_{c}^{2} ( η - ξ ) = 0\end{matrix} \qquad Equation ( 1 )$$

where ξ is the modal coordinate of the structure, βₛ=2δζₛωₛ; ζₛ is the structural damping ratio, ωₛ is the structural natural frequency, η is the modal coordinate of the compensator, β_{c}=2ζ_{c}ω_{c}, ζₛ is the compensator damping ratio, ωₛ is the compensator natural frequency, γ is the scalar gain applied to the feedback signal, f(t) is the forcing term.

In the Laplace domain, Equation (1) can be expressed as

$$\{ \begin{matrix}\overline{ξ} {s}^{2} + {β}_{s} \overline{ξ} s + {ω}_{s}^{2} ( \overline{ξ} - γ \overline{η} ) = \overline{f} \\ \overline{η} {s}^{2} + {β}_{c} \overline{η} s + {ω}_{c}^{2} ( \overline{η} - \overline{ξ} ) = 0\end{matrix} \qquad Equation ( 2 )$$

So that solving for η in the equation (2) and replacing its expression in the Equation (1), we obtain:

$$[ ( {s}^{2} + {β}_{s} s + {ω}_{s}^{2} ) - \frac{{γω}_{s}^{2} {ω}_{c}^{2}}{( {s}^{2} + {β}_{c} s + {ω}_{c}^{2} )} ] \overline{ξ} = \overline{f} \qquad Equation ( 3 )$$

Thus the characteristic equation of the system is:
(s²+βₛs+ωₛ²)(s²+β_{c}s+ω_{c}²)−γωₛ²ω_{c}²=0 Equation (4)

The Routh arrays for the characteristic Equation (4) are:

$$\begin{matrix}1 & {ω}_{s}^{2} + {ω}_{c}^{2} + {β}_{s} {β}_{c} & {ω}_{s}^{2} {ω}_{c}^{2} ( 1 - γ ) \\ {β}_{s} + {β}_{c} & {β}_{s} {ω}_{c}^{2} + {β}_{c} {ω}_{s}^{2} & 0 \\ \frac{{β}_{s} {ω}_{s}^{2} + {β}_{c} {ω}_{c}^{2} + {β}_{s} {β}_{c} ( {β}_{s} + {β}_{c} )}{{β}_{s} + {β}_{c}} & {ω}_{s}^{2} {ω}_{c}^{2} ( 1 - γ ) & 0 \\ \frac{{β}_{s} {β}_{c} ( {( {ω}_{s}^{2} - {ω}_{c}^{2} )}^{2} ( {β}_{s} + {β}_{c} ) ( {β}_{s} {ω}_{c}^{2} + {β}_{c} {ω}_{s}^{2} ) ) + {γ ( {β}_{s} + {β}_{c} )}^{2} {ω}_{s}^{2} {ω}_{c}^{2}}{{β}_{s} {ω}_{s}^{2} + {β}_{c} {ω}_{c}^{2} + {β}_{s} {β}_{c} ( {β}_{s} + {β}_{c} )} & 0 & 0 \\ {ω}_{s}^{2} {ω}_{c}^{2} ( 1 - γ ) & 0 & 0\end{matrix}$$

Since the elements of the first column have the same sign only if γ<1, the closed loop system is stable if γ<1.

In many applications, it is required that the introduction of the active vibration absorber should not introduce new vibration modes. This can be achieved by forcing the characteristic Equation (4) to have identical roots, that is
(s²+2ζₛωₛs+ωₛ²)(s²+ζ_{c}ωₛs+ω_{c}²)−γωₛ²ω_{c}²=(s²+ζ_{f}ω_{f}s+ω_{f}²)² Equation (5)
where ζf is the closed-loop system damping and (of is the closed-loop system frequency. Equating the terms of same power of s in Equation (5), we obtain the following equations:

$$\begin{matrix}\{ \begin{matrix}2 {ζ}_{f} {ω}_{f} = {ζ}_{s} {ω}_{s} + {ζ}_{c} {ω}_{c} \\ 2 {ω}_{f}^{2} + 4 {ζ}_{f}^{2} {ω}_{f}^{2} = {ω}_{s}^{2} + 4 {ζ}_{s} {ω}_{s} {ζ}_{c} {ω}_{c} + {ω}_{c}^{2} \\ 2 {ζ}_{f} {ω}_{f}^{3} = {ω}_{s}^{2} {ζ}_{c} {ω}_{c} + {ω}_{c}^{2} {ζ}_{s} {ω}_{s} \\ {ω}_{f}^{4} = {ω}_{s}^{2} {ω}_{c}^{2} ( 1 - γ )\end{matrix} & Equations ( 6 ) , ( 7 ) , ( 8 ) and ( 9 )\end{matrix}$$

From equations (6-9), the cross over conditions can be derived as
ωₛ²(1−ζₛ²)=ω_{c}²(1−ζ_{c}²) Equation (10)
or
ω_{c}ζ_{c}=ωₛωₛ Equation (11)

Assuming that the PPF compensator will be operated at the cross over point, a cross over condition can be chosen to design a compensator. To add damping in a structure without changing too much the natural frequency of the structure, we use the cross over condition Equation (6) which states that the damped natural frequencies of the structure and the compensator are the same. The condition fixes the first design parameter ωc to be

$${ω}_{c} = {ω}_{s} \frac{\sqrt{1 - {ζ}_{s}^{2}}}{\sqrt{1 - {ζ}_{c}^{2}}} \qquad Equation ( 12 )$$

Using this condition and Equation (6) and Equation (7), the closed loop natural frequency is:

$${ω}_{f} = {{ω}_{s} ( 1 - {ζ}_{s}^{2} + {ζ}_{s} {ζ}_{c} \frac{\sqrt{1 - {ζ}_{s}^{2}}}{\sqrt{1 - {ζ}_{c}^{2}}} )}^{\frac{1}{2}} \qquad Equation ( 13 )$$

Substituting Equation (13) in Equation (6), the gain of the compensator is:

$$γ = 1 - \frac{1 - {ζ}_{c}^{2}}{1 - {ζ}_{s}^{2}} {( 1 - {ζ}_{s}^{2} + {ζ}_{s} {ζ}_{c} \frac{\sqrt{1 - {ζ}_{s}^{2}}}{\sqrt{1 - {ζ}_{c}^{2}}} )}^{2} \qquad Equation ( 14 )$$

And finally, Equation (6) is:

$${ζ}_{f} = \frac{1}{2} \frac{( {ζ}_{s} + {ζ}_{c} \frac{\sqrt{1 - {ζ}_{s}^{2}}}{\sqrt{1 - {ζ}_{c}^{2}}} )}{{( 1 - {ζ}_{s}^{2} + {ζ}_{s} {ζ}_{c} \frac{\sqrt{1 - {ζ}_{s}^{2}}}{\sqrt{1 - {ζ}_{c}^{2}}} )}^{\frac{1}{2}}} \qquad Equation ( 15 )$$

The D/A converter 116 is coupled to the DSP and receives the digital control signal. The D/A converter converts the digital control signal to an analog control signal. In the illustrated embodiment, the digital to analog converter 116 comprises commercially available NI-6025E, and other D/A converters may equivalently be used.

Piezo power amplifier 118 is coupled to the digital to analog converter 116 to receive the analog control signal. The piezo power amplifier amplifies the analog control signal to a desired voltage. In the illustrated embodiment, the desired voltage is determined by the control algorithm, based on the sensor response, to minimize the resonance vibrations in the support frame.

Actuator 130 is coupled to the piezo power amplifier and receives the analog control signal. The actuator generates a force response to the electrical stimulation of the analog control signal. The force response counteracts the resonance vibrations in the support frame. It will be appreciated here that other compatible actuators including piezoelectric materials, magnetostrictive materials, electrostrictive materials, and electromagnetic devices, among others may be used.

The disclosed embodiments and equivalents thereof provide various advantages, including a closed-loop active vibration control to reduce the vibration level thereby improving the CT image quality. The mechanical vibration energy is dissipated through electronic devices. The vibration reduction is very significant at the low frequency region, in which most resonance vibrations occur.

While only certain features of the invention have been illustrated and described herein, many modifications and changes will occur to those skilled in the art. It is, therefore, to be understood that the appended claims are intended to cover all such modifications and changes as fall within the true spirit of the invention

1. An apparatus for active vibration control of resonance vibrations in a computed tomography (CT) system, the apparatus comprising:
a sensor coupled to a support frame of the CT system, the sensor configured to detect resonance vibrations signals in the support frame and convert the vibration signals to a corresponding electrical signal; and
a control device coupled to the sensor, the control device configured for implementing a control algorithm responsive to the electrical signal to generate a corresponding control signal, the control signal being used for counteracting the resonance vibrations in the support frame.

2. The apparatus of claim 1, wherein the control device further comprises a digital signal processor, the digital signal processor being configured to implement the control algorithm to process the electrical signal to generate the corresponding control signal.

3. The apparatus of claim 1, wherein the sensor is selected from the group consisting of an accelerometer, a velocity sensor, a displacement sensor, a deformation sensor, a strain gauge, a piezo wafer, and a Polyvinyl Fluoride (PVDF) film sensor, each having a corresponding appropriate control algorithm modification.

4. The apparatus of claim 1, further comprising an actuator having a force response to a magnetic or an electrical stimulation, the actuator configured to receive the control signal and use the force response to the control signal for counteracting the resonance vibration in the support frame.

5. The apparatus of claim 1, wherein the control algorithm is selected from the techniques consisting of a positive position feedback control technique, an acceleration feed back control technique, a velocity feed back control technique, and a collocated rate feedback control.

6. The apparatus of claim 1, wherein the electrical signal is an alternating current (AC) voltage signal.

7. The apparatus of claim 1, further comprising a charge amplifier coupled to the sensor, the charge amplifier amplifying the electrical signal.

8. The apparatus of claim 7, further comprising an analog to digital converter converting the electrical signal to digital electric signal, the digital electric signal being provided to the digital signal processor to generate a digital control signal.

9. The apparatus of claim 8, further comprising a digital to analog converter coupled to the digital signal processor, the digital to analog converter receiving the digital control signal and generating the control signal.

10. The apparatus of claim 9, further comprising a piezo amplifier coupled to the digital to analog converter, the piezo electric amplifier amplifying the control signal and the control signal being provided to the actuator.

11. A method for retrofitting a computed tomography (CT) system with an apparatus for active vibration control of resonance vibrations in a support frame of the CT system, the method comprising:
coupling a sensor to a support frame of the CT system, the sensor configured to detect resonance vibrations signals in the support frame and convert the vibration signals to a corresponding electrical signal; and
coupling a control device to the sensor, the control device configured for implementing a control algorithm responsive to the electrical signal to generate a corresponding control signal, the control signal being used for counteracting the resonance vibrations in the support frame.

12. The method of claim 11, further comprising coupling an actuator to the control device and the support frame, the actuator configured to generate a force response to the control signal and use the force response for counteracting the resonance vibration in the support frame.

13. The method of claim 11, wherein the control device further comprises a digital signal processor, the digital signal processor being configured to implement the control algorithm to process the electrical signal to generate the corresponding control signal.

14. The method of claim 12, further comprising coupling a charge amplifier to the sensor.

15. The method of claim 14, further comprising coupling an analog to digital converter to the charge amplifier.

16. The method of claim 15, further comprising coupling a digital to analog converter to the digital signal processor.

17. The method of claim 16, further comprising coupling a piezo amplifier to the digital to analog converter.

18. A method for controlling resonance vibrations in a CT system, the method comprising:
detecting a vibration in a support frame of the CT system to generate a vibration signal; and
generating control signals by implementing a control algorithm responsive to the vibration signal, the control signals configured to counteract the resonance vibration in the support frame.

19. The method of claim 18, wherein the control algorithm is selected from the techniques consisting of a positive position feedback control technique, an acceleration feed back control technique, a velocity feed back control technique, and a collocated rate feedback control.

20. The method of claim 18, wherein the generating control signals comprises:
converting the vibration signal to a corresponding electrical signal; and
implementing the control algorithm to process the electrical signal and generate the corresponding control signal.

21. The method of claim 20, further comprising receiving the control signal and using the control signal for counteracting the vibration in the CT system.

22. The method of claim 20, wherein the electrical signal is an AC voltage signal.

23. The method of claim 20, further comprising amplifying the electrical signal prior to the implementing the control algorithm.

24. The method of claim 20, further comprising converting the electrical signal to a digital electrical signal, the control algorithm being implemented on the digital electrical signal to generate a digital control signal.

25. The method of claim 24, further comprising converting the digital control signal and generating a control signal.

26. The method of claim 18, further comprising amplifying the control signals, the control signal being used to counteract the resonance vibrations.
